(19) United States
(12) Patent Application Publication
(10) Pub. No.: US 2024/0060399 A1
(43) Pub. Date: Feb. 22, 2024

(54) METHOD FOR MAKING A PERMEABLE MEDIA AND PERMEABLE MEDIA

(71) Applicant: Aaron C. Hammer, Houston, TX (US)

(72) Inventor: Aaron C. Hammer, Houston, TX (US)

(73) Assignee: Baker Hughes Oilfield Operations LLC, Houston, TX (US)

(21) Appl. No.: 17/891,263

(22) Filed: Aug. 19, 2022

(51) Int. Cl. E21B 43/08; F03G 7/06

(52) U.S. Cl. CPC E21B 43/082; F03G 7/0614

(57) ABSTRACT

A permeable material including a plurality of hollow structures having a plurality openings therein allowing fluid transfer between an inside volume of the hollow structure and an environment outside of the hollow structure, and a bond between adjacent ones of the plurality of hollow structures. A downhole filtration tool including a mandrel, and the material disposed about the mandrel. An embodiment of a method for making a permeable material including aggregating a plurality of hollow structures into a mass, and bonding the structures together. An embodiment of a borehole system including a borehole in a subsurface formation, and the material, disposed in the borehole.

### BACKGROUND

In the resource recovery and fluid sequestration industries it is often desirable to filter fluids that are flowing within a borehole. Filtration materials are many in the art but often have drawbacks associated with limited permeability. The art will well receive additional filtration material that can be used in the downhole environment.

### SUMMARY

An embodiment of a permeable material including a plurality of hollow structures having a plurality openings therein allowing fluid transfer between an inside volume of the hollow structure and an environment outside of the hollow structure, and a bond between adjacent ones of the plurality of hollow structures.

An embodiment of a downhole filtration tool including a mandrel, and the material disposed about the mandrel.

An embodiment of a method for making a permeable material including aggregating a plurality of hollow structures into a mass, and bonding the structures together.

An embodiment of a borehole system including a borehole in a subsurface formation, and the material, disposed in the borehole.

### BRIEF DESCRIPTION OF THE DRAWINGS

The following descriptions should not be considered limiting in any way. With reference to the accompanying drawings, like elements are numbered alike:

FIG. 1 is a view of three of the hollow structures disclosed herein;

FIG. 2 is a view of a permeable material using the hollow structures illustrated in FIG. 1;

FIG. 3 is a schematic view of a downhole filtration tool including the material disclosed herein; and

FIG. 4 is a view of a borehole system including the permeable material as disclosed herein.

### DETAILED DESCRIPTION

A detailed description of one or more embodiments of the disclosed apparatus and method are presented herein by way of exemplification and not limitation with reference to the Figures.

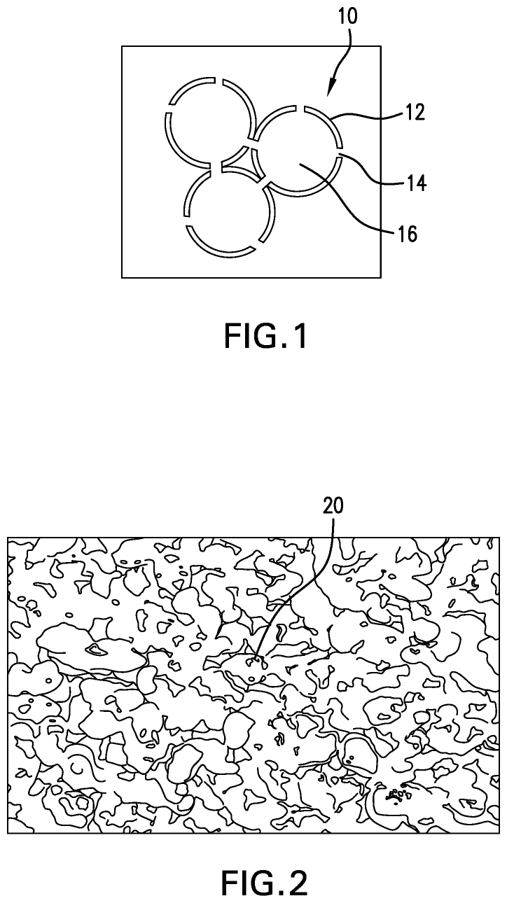

Referring to FIG. 1, a group of three hollow structures 10 are illustrated. Each structure 10 includes an outer wall 12 having at least two openings 14 therein through which fluid may move between an environment outside of the wall 12 to a volume 16 defined inwardly of the wall 12. The at least two openings ensures that fluid may pass from outside of the structure 10 through a first of the openings 14 into the volume 16 and out of the volume 16 through the other of the at least two openings 14 to an environment outside of the wall 12. Fluid flow may flow in either direction. It is to be understood that any number of openings 14 is contemplated bounded only by available space to create openings through the wall 12. Fluid flow is permitted in any direction through the volume 16. The structures 10 may comprise a number of materials. For example, the wall 12 may comprise a shape memory material, a plastic material, a thermoplastic material, a metal material, epoxy, polyurethane and combinations including at least one of the foregoing, the form of the wall 12 being a solid or a foam, for example. In some embodiments, the structures 10 may be foamed pellets or may be extrusions under high pressure such that foaming will be a result of passing through the extruder. Regardless of method of foaming, it is the case that consistency in permeability of a foam material is better achieved in smaller volumes than is larger volumes. The structures 10 therefore provide an advantage in assuring permeability in the structures 10 and hence in a permeable material created thereby. Structures 10 may be of differing size and geometry or maybe homogenous.

Once an appropriate number of structures 10 are created, they are aggregated and bonded together using a bonding agent that is the same or different in material than the structures 10. In an embodiment, the structures 10 are sintered together. In another embodiment the bonding agent may be an adhesive, which may be a glue, a cement, solvent, etc. It is also contemplated that different portions of the same overall structure may employ different bonding paradigms. For example, One portion might use the same material for bonding and a different portion of the same overall structure might use a different material for bonding. Bonding the structures 10 together creates porosity in the finished material 20 (see FIG. 2) and therefore permeability that also benefits from the permeability of the structures 10 themselves,

The material 20 if a shape memory material, may be compressed and frozen in place to be configured for example around a holed tubular member for running in a borehole 22 and then expanded when the member is at a target depth. Expansion may be based upon temperature, pressure, downhole fluids, applied fluids, electric signal etc.

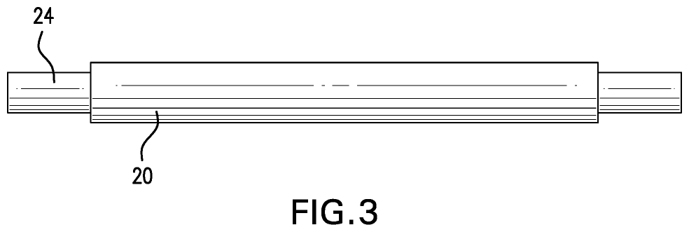

In one embodiment, referring to FIG. 3, the material 20 is disposed upon a mandrel 24 to act as a downhole filtration tool. The material 20 would in one iteration be compressed prior to running in the hole and expanded when at depth but it is also contemplated that the material remains in the same geometric form after reaching target depth.

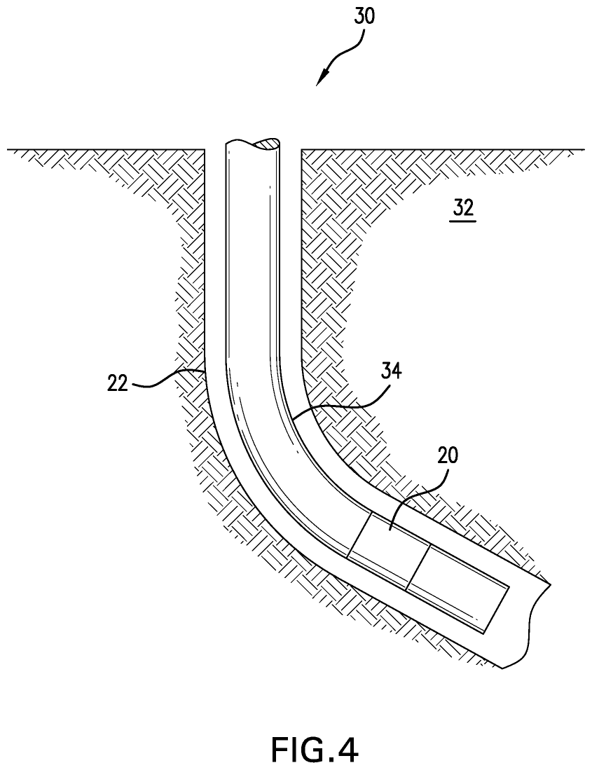

Referring to FIG. 4, a borehole system 30 is illustrated. The system 30 comprises a borehole 22 in a subsurface formation 32. A string 34 is disposed within the borehole 22. And the material 20 is disposed as a part of the string 34.

Set forth below are some embodiments of the foregoing disclosure:

Embodiment 1: A permeable material including a plurality of hollow structures having a plurality openings therein allowing fluid transfer between an inside volume of the hollow structure and an environment outside of the hollow structure, and a bond between adjacent ones of the plurality of hollow structures.

Embodiment 2: The permeable material as in any prior embodiment, wherein the structures are shape memory material.

Embodiment 3: The permeable material as in any prior embodiment, wherein the bond comprises a shape memory material.

Embodiment 4: The permeable material as in any prior embodiment, wherein the bond is the same material as the structures.

Embodiment 5: The permeable material as in any prior embodiment, wherein the bond material is a different material than the structures.

Embodiment 6: The permeable material as in any prior embodiment, wherein the bond is created by an adhesive.

Embodiment 7: The permeable material as in any prior embodiment, wherein the bond is a sintered bond.

Embodiment 8: The permeable material as in any prior embodiment, wherein one or more of the hollow structures is a foam material.

Embodiment 9: The permeable material as in any prior embodiment, wherein the foam material is permeable foam.

Embodiment 10: The permeable material as in any prior embodiment, wherein at least one of the plurality of hollow structures includes a multiplicity of openings therein.

Embodiment 11: The permeable material as in any prior embodiment, wherein the hollow structures are of varying size and geometry.

Embodiment 12: The permeable material as in any prior embodiment, wherein the hollow structures are of homogenous size and geometry.

Embodiment 13: A downhole filtration tool including a mandrel, and the material as in any prior embodiment disposed about the mandrel.

Embodiment 14: The tool as in any prior embodiment wherein the material is expandable.

Embodiment 15: A method for making a permeable material including aggregating a plurality of hollow structures into a mass, and bonding the structures together.

Embodiment 16: The method as in any prior embodiment, wherein the bonding is sintering.

Embodiment 17: The method as in any prior embodiment, further comprising foaming a material to create the hollow structures.

Embodiment 18: The method as in any prior embodiment further comprising extruding material to create the hollow structures.

Embodiment 19: A borehole system including a borehole in a subsurface formation, and the material as in any prior embodiment, disposed in the borehole.

Embodiment 20: A borehole system including a borehole in a subsurface formation, and the tool as in any prior embodiment, disposed in the borehole.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” includes a range of ±8% of a given value.

The teachings of the present disclosure may be used in a variety of well operations. These operations may involve using one or more treatment agents to treat a formation, the fluids resident in a formation, a borehole, and/or equipment in the borehole, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, production, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A permeable material comprising:
a plurality of hollow structures having a plurality openings therein allowing fluid transfer between an inside volume of the hollow structure and an environment outside of the hollow structure; and
a bond between adjacent ones of the plurality of hollow structures.

2. The permeable material as claimed in claim 1, wherein the structures are shape memory material.

3. The permeable material as claimed in claim 1, wherein the bond comprises a shape memory material.

4. The permeable material as claimed in claim 1, wherein the bond is the same material as the structures.

5. The permeable material as claimed in claim 1, wherein the bond material is a different material than the structures.

6. The permeable material as claimed in claim 1, wherein the bond is created by an adhesive.

7. The permeable material as claimed in claim 1, wherein the bond is a sintered bond.

8. The permeable material as claimed in claim 1, wherein one or more of the hollow structures is a foam material.

9. The permeable material as claimed in claim 7, wherein the foam material is permeable foam.

10. The permeable material as claimed in claim 1, wherein at least one of the plurality of hollow structures includes a multiplicity of openings therein.

11. The permeable material as claimed in claim 1, wherein the hollow structures are of varying size and geometry.

12. The permeable material as claimed in claim 1, wherein the hollow structures are of homogenous size and geometry.

13. A downhole filtration tool comprising:
a mandrel; and
the material as claimed in claim 1 disposed about the mandrel.

14. The tool as claimed in claim 13 wherein the material is expandable.

15. A method for making a permeable material comprising:
aggregating a plurality of hollow structures into a mass; and
bonding the structures together.

16. The method as claimed in claim 15, wherein the bonding is sintering.

17. The method as claimed in claim 15, further comprising foaming a material to create the hollow structures.

18. The method as claimed in claim 15 further comprising extruding material to create the hollow structures.

19. A borehole system comprising:
a borehole in a subsurface formation; and
the material as claimed in claim 1, disposed in the borehole.

20. A borehole system comprising:
a borehole in a subsurface formation; and
the tool as claimed in claim 13, disposed in the borehole.
